(19) United States
(12) Patent Application Publication
(10) Pub. No.: US 2004/0075684 A1
(43) Pub. Date: Apr. 22, 2004

(54) System, method and computer program product for constructing and managing CAD data in cooperative engineering environments

(76) Inventors: Paul Chater, London (GB); Josh Schifter, Exton, PA (US)

Correspondence Address: VENABLE, BAETJER, HOWARD AND CIVILETTI, LLP, P.O. BOX 34385, WASHINGTON, DC, 20043-9998, US

(21) Appl. No.: 10/274,143

(22) Filed: Oct. 21, 2002

(51) Int. Cl. G09G 5/00

(52) U.S. Cl. 345/744; 345/762

(57) ABSTRACT

A system and method for constructing and managing style data is provided. New styles can be created based on existing styles with only the minimum number of changes made to the new style. A complete set of attributes for the new is obtained even though only a sub-set of the attributes may have been defined.

### CROSS-REFERENCE TO RELATED APPLICATION

The present application is related to U.S. patent application Ser. No. ______, Confirmation No. ______, (Attorney Docket No. 36488-169851) filed Oct. 21, 2002 entitled “System, Method and Computer Program Product for Managing CAD Data,” to Malkan et al., of common assignee to the present invention, the contents of which are incorporated herein by reference in their entirety.

### FIELD OF THE INVENTION

The present invention relates generally to systems and methods for managing CAD data and more particularly for constructing and managing styles for CAD data.

### BACKGROUND OF THE INVENTION

Computer-aided design (CAD) drawings prepared by architects, engineers, designers, planners, and the like require large amounts of data to be stored in files. CAD software includes an API to access the large quantities of data. Applications such as, e.g., MicroStation® products, which are developed by Bentley Systems, Inc., Exton, Pa. U.S.A., and AutoCAD® products, which are developed by Autodesk, Inc., San Rafael, Calif., U.S.A. are typical of such CAD software, which may be used in the Engineering, Construction, and Operations (ECO) marketplace.

A typical CAD project employed in the engineering context is stored in numerous files. Each file typically contains one or more engineering models, each of which represents an engineering domain (e.g., structural, electrical, mechanical, plumbing). Moreover, each engineering model requires numerous items represented by a series of elements to support the complex and precise nature of each design. In this context, the term “element” is used to mean a record containing a variable number of bytes of data arranged in a format that can be interpreted by a program. The term “element” differs from the common notion of an “object” in that each element can have a variable number of bytes, whereas the size of an object is typically defined by its class. It is the variable-sized nature of elements that causes their persistent storage to be complicated, because they cannot be written in fixed sized records and arranged in tables, as is typically done in relational databases, for example.

Each item in a model is represented by at least one element or an aggregation of elements. For example, a structural drawing can hold the column and beam layout for a floor plan, which are internally represented by lines, squares and rectangles and additional properties. In this example, an individual beam may be a collection of lines, squares and rectangle elements. The structure of the floor plan may be more complex and require many nested levels of elements to accurately provide a structural representation.

Attributes define the characteristics of a graphical entity such as an element, for example, its color or line width, and how the element is displayed to a user. It is common practice for attributes of elements stored in a CAD data file to be controlled by a named style. A style itself is a non-graphical entity which records a particular set of values for the attributes needed to construct the element.

Typically, the more attributes required to describe a graphical entity, the more beneficial it is to store those attributes within a style. For example, graphical text and dimensions each require many different attributes to complete define their graphical appearance. For a text element, some examples of such attributes are: height, width, font, underline, bold, intercharacter spacing, line spacing etc.

In a CAD document, many of the specific instances of a particular type of graphical entity use a similar collection of attributes with a small variation. However, current CAD systems do not take advantage of the small variation between styles. These CAD systems require that all the attributes for a new style be redefined, even if many of those attributes are common amongst styles.

Thus, there is a need for a system and method to reduce the burden on the user for the administration for this data. centralize, control and distribute predefined information used for creating CAD files and models. The system and method should allow for.

### SUMMARY OF THE INVENTION

In an exemplary embodiment of the invention, a method for constructing styles is provided. The method comprises accessing a database storing predefined styles; receiving user input selecting one of the predefined styles; displaying attributes of the selected predefined style to the user; receiving input from the user modifying attributes of the predefined style; and storing the modified attributes as a new style.

In another embodiment of the invention, a computer useable information storage medium storing computer readable program code is provided The code causes a computer to perform the steps of providing a graphical user interface (GUI) for constructing styles; obtaining predefined styles including predefined attributes from a database; displaying the predefined styles via the GUI; receiving input from the GUI to create a new style; receiving input via the GUI selecting a parent style from the predefined styles; displaying the predefined attributes of the parent style via the GUI; receiving input via the GUI modifying the attributes; and storing the new style including the modified attributes.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 is a schematic diagram of a network according to the embodiment of the invention;

FIG. 2 is a schematic diagram of a graphical user interface according to an embodiment of the invention;

FIG. 3 is a schematic diagram of a graphical user interface according to an embodiment of the invention;

FIG. 4 is a schematic diagram of a graphical user interface according to an embodiment of the invention;

FIG. 5. is a schematic diagram of a graphical user interface according to an embodiment of the invention;

FIG. 6 is a schematic diagram of a graphical user interface according to an embodiment of the invention; and

FIG. 7 is a schematic diagram of a graphical user interface according to an embodiment of the invention.

### DETAILED DESCRIPTION OF AN EXEMPLARY EMBODIMENT OF THE PRESENT INVENTION

A system and method for constructing and managing style data is provided. New styles can be created based on existing styles with only the minimum number of changes made to the new style. A complete set of attributes for the new style is obtained even though only a sub-set of the attributes may have been defined. Although embodiments of the invention are described below using text styles as a specific example, the invention is equally applicable and includes other styles, such as dimension styles.

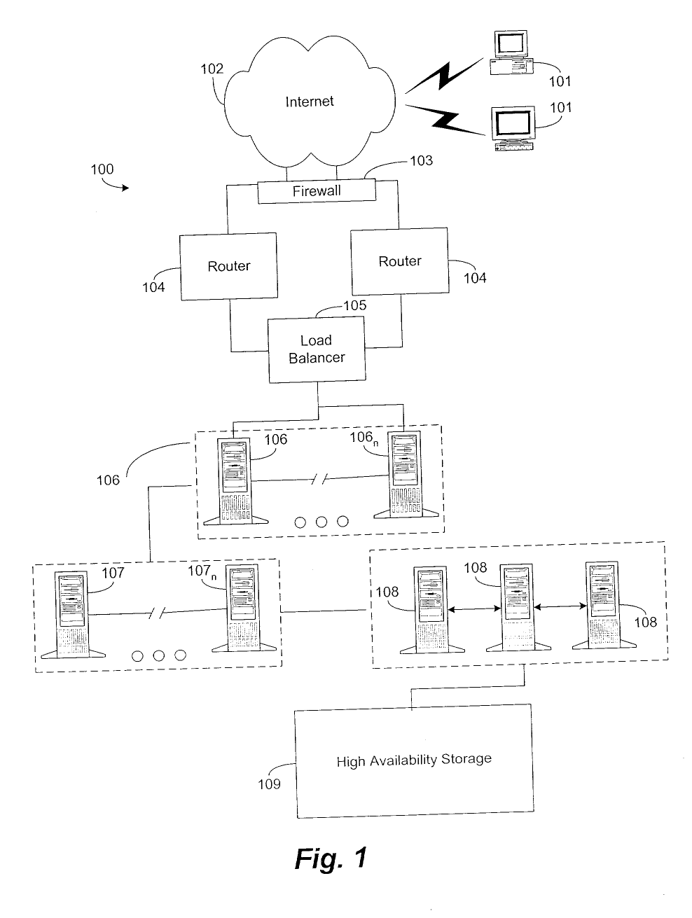

The method may be implemented via a software program operating in a client-server environment. The software program may be part of a CAD software program or a separate program. The software program may include portions running on the client, the server, or both. Referring now to the drawings, there is shown in FIG. 1 a schematic diagram of a system 100 that provides multi-user access to data or information, such as text style data, stored at a central location. System 100 is intended to be accessed by a plurality of clients or users 101. Such clients 101, in turn, suitably comprise one or more conventional personal computers and workstations. It should be understood, nevertheless, that other clients 101 such as Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances fall within the spirit and scope of the present invention.

Clients 101 of all of the above types suitably access system 100 by way of the Internet 102. By use of the term “Internet”, it should be understood that the foregoing is not intended to limit the present invention to a network also known as the World Wide Web. It includes intranets, extranets, Virtual Private Networks (VPNs), Local Area Networks (LANs), Wide Area Networks (WANs), and the like.

Clients 101 are directed to web servers 106 through firewall 103, routers and proxy servers 104 and load balancer 105. Each of the web server 106₁, 106₂, . . . 106ₙ is, in turn, preferably comprised of a HP LH3R NetServer (manufactured by Hewlett-PackardCorporation). Preferably, each of the web servers 106₁, 106₂, . . . 106ₙ further comprises a Microsoft® Windows® NT operating system, and Netscape Enterprise Server, Release 3.6.3 (developed by Netscape Communications, a subsidiary of America Online, Inc., Dulles, Va. U.S.A.). Certificate servers (e.g., web certificate servers and wireless certificate servers, which are available from VeriSign, Inc., Mountain View, Calif. U.S.A.) may optionally be deployed on each of the web servers 106₁, 106₂, . . . 106ₙ.

System 100 further comprises a plurality of application servers 107₁, 107₂, . . . 107ₙ, coupled to and providing support to the web servers 106₁, 106₂, . . . 106ₙ. Each of the application servers 107₁, 107₂, . . . 107ₙ is, like the web servers 106₁, 106₂, . . . 106ₙ, preferably comprised of a HP LH3R NetServer. System 100 further comprises a plurality of databases 108₁, 108₂, . . . 108ₙ, coupled to the application servers, preferably comprised of HP LH3R NetServers using Oracle. High availability storage 109 for the database 108 is also provided.

Information and data relating to a design project is stored in databases 108 and high availability storage 109. Clients 101 can access the database 108 through servers 106, 107. Of course, many variations of the above-described exemplary client-server environment are permissible within the scope of the present invention.

A text style comprises a group of text attributes such as font type, width, height, and color. The text style is applied to a text element in a CAD design file and controls how the text is displayed. Text styles allow a user to place text within a design file in a consistent and automated manner.

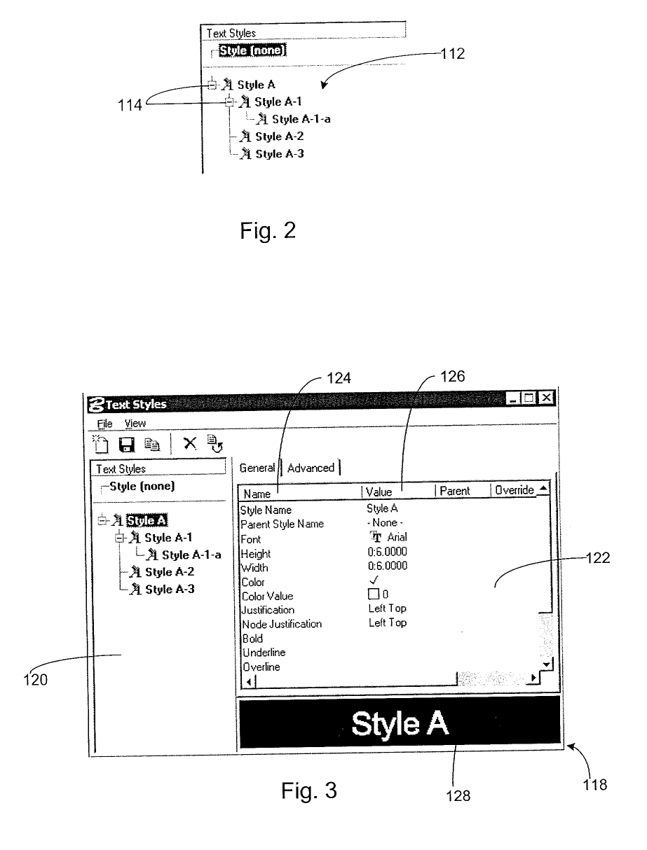

An exemplary embodiment of the invention provides an interface for constructing text with available system fonts and a wide variety of text attributes. The text style data is arranged and stored using hierarchies in order to take advantage of the reuse of a large portion of the attributes of existing text styles. FIG. 2 illustrates an example of a text style hierarchy. The structure of the text style hierarchy is a general n-tree 112 comprising a number of nodes 114. Each node can have an arbitrary number of children, but only a single parent. The tree can extend to an arbitrary depth. Style A is the base text style for all of the other text styles in the example shown. Text style hierarchies are discussed in more detail below.

CAD software can be used to create and manage styles. A CAD administrator can define styles. The styles are typically standards that are applied across a project or design file. In order to be able to implement the standard styles, users of the CAD software must have access to the styles. Therefore, the styles should be stored at a location that is accessible to the users. Database 108 is such a location. Users can select from the predefined styles and apply those styles to elements of their design files. Storing the styles at a central location also allows the CAD administrator control over the styles. In some instances, the predefined style may not be suitable for a user's purpose. Thus, embodiments of the present invention provide a means for constructing and managing styles.

FIG. 3 illustrates a graphical user interface (GUI) used to construct and manage text styles according to an embodiment of the invention. GUI 118 includes two dialog boxes 120, 122. Dialog box 120 displays the existing text styles according to their hierarchy. Here, the text style hierarchy of FIG. 2 is used as an example. The existing text styles may be previously defined by an administrator or by users. Text styles are obtained from a central location, for example database 108, and provided via the GUI 118 to a user.

Dialog box 122 displays the attributes of a selected text style. In FIG. 3, Style A is selected in dialog box 120 and its attributes are displayed in dialog box 122. An example of text having the selected style applied thereto is shown in box 128. Names for the various attributes of Style A are presented in “Name” column 124. Some examples of the attributes include height, width, color, bold, underline, etc. Values for the attributes of column 124 are displayed in “Value” column 126 to correspond to the appropriate attribute name in column 124. For example, the attribute “Style Name” in column 124 has a value of “Style A” in column 126, indicating the currently selected text style is Style A. An attribute “Parent Style Name” is also provided in column 124. Notice that a value of “-none-” is displayed in column 126 for the attribute “Parent Style Name”. This indicates that “Style A” has no parent style, that is, Style A is at the top of the example hierarchy. All the other styles in the example hierarchy inherit all of their attributes from “Style A”, except for specific attributes that the user may choose to override. An administrator may be given the authority to set those attributes that can be overridden.

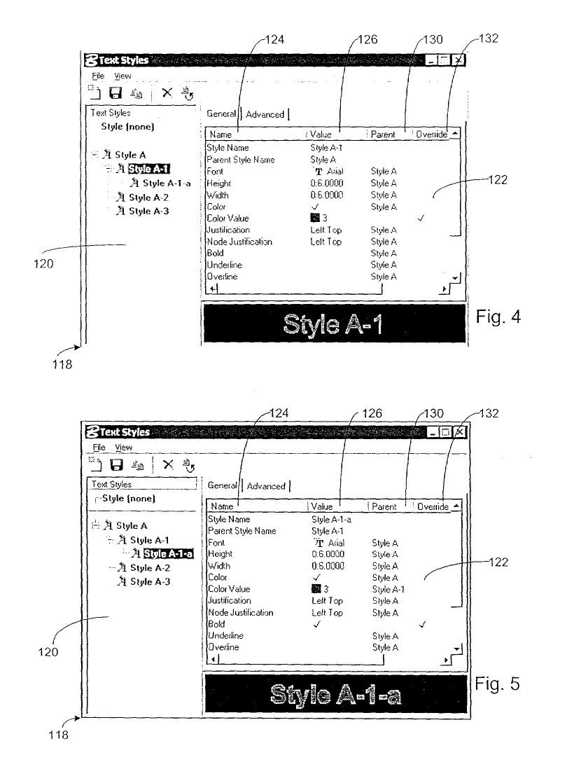

Turning now to FIG. 4, Style A-1 is selected and its attributes are displayed in dialog box 122. As indicated by the hierarchy displayed in dialog box 120, Style A-1 is a child of Style A. More specifically, Style A-1 is a direct child of Style A, that is, there are no intervening text styles between Style A and Style A-1 from which Style A-1 inherits attributes. Dialog box 122 also includes a column 130 indicating the parent text style from which the selected text style inherits its attributes. As can be seen from column 130, all of Style A-1's attributes are inherited from Style A, except for the 1) “Style Name” 2) “Parent Style Name” and 3) “Color Value”. “Style Name” and “Parent Style Name” attributes cannot be inherited from a parent text style, as these attributes are unique to each text style. On the other hand, the “Color Value” attribute for Style A-1 has been specifically changed from Style A. Style A and its children all use a color of white, but Style A-1 overrides the color attribute to red. Thus, when text is created using the Style A and Style A-1, the color of the text is different.

“Override” column 132 in dialog box 122 indicates when an attribute is overridden. A check or other indicator is placed in column 132 corresponding to the attribute that has been changed. In this case, all the attributes are controlled by Style A, except “Color Value”. Thus, the “Parent” column 130 indicates which parent text style is controlling the attribute The “Override” column 132 indicates that “Color Value” is controlled locally by Style A-1.

Referring now to FIG. 5, Style A-1-a is selected in dialog box 120 and its attributes are displayed in dialog box 122. As is indicated by the hierarchy in dialog box 120, Style A-1-a is a direct child of Style A-1 and a grandchild of Style A. Accordingly, Style A-1-a may have its attributes controlled by both Style A and Style A-1-a. Notice in the “Parent” column 130 that most of the attributes of Style A-1-a are controlled by Style A, with a few exceptions. As mentioned before, “Style Name” and “Parent Style Name” attributes cannot be inherited and are therefore not controlled by any type of parent text style. The “Color Value” attribute in column 124 is controlled by Style A-1, as indicated in the corresponding entry in column 130. The attribute “Bold” in column 124 has been changed from its value in Style A and in Style A-1. The “Bold” attribute has been enabled as indicated in a corresponding entry in column 126. The “Override” column 132 indicates the “Bold” attribute is locally controlled by Style A-1-a.

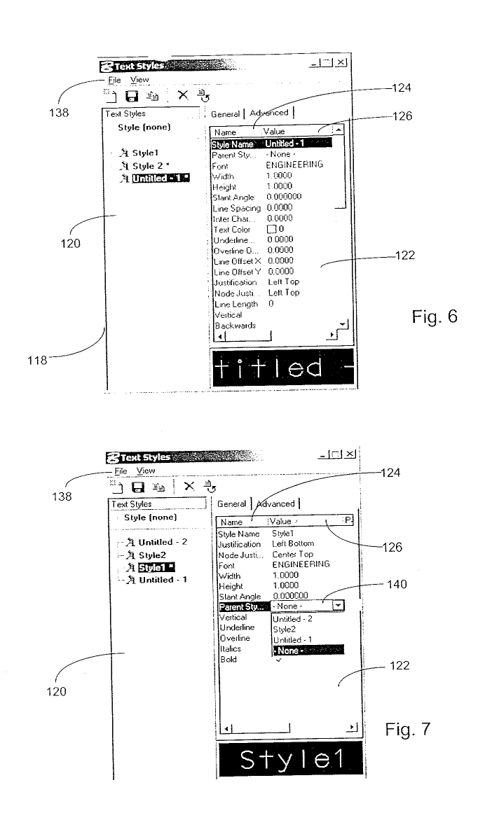

FIGS. 6 and 7 illustrate a GUI that a user may access to creating text styles, i.e. child text styles, that inherit some of their attributes from predefined text styles, i.e. parent text styles. As mentioned above, predefined text styles are typically stored at a central location so that the various users of the CAD system can access them. The user opens the GUI to create a new text style. The CAD system accesses the database to retrieve predefined text styles stored therein. The predefined text styles are then displayed to the user via dialog box 120 in GUI 118 as shown in FIG. 6. The user selects a text style from those displayed in dialog box 120. The attributes of the selected text style are then displayed in dialog box 122 as is described above. The user can quickly scan though the existing text styles and their attributes to determine if any existing text style meets the current needs. If no existing text style meets the current need, but is very similar, the user can create a new text style based on an existing, similar text style. The user can make modifications to the attributes of the similar, existing text style to meet their requirements, without having to redefine all the attributes for a new text style.

In order to create a new text style, the user chooses File >New from the menu bar 138 of GUI 118 in FIG. 4. A new untitled text style is generated by the system and appears in GUI 118. The attributes of the new style are automatically set to match those of the style that was selected when the “New” command was issued. The user selects the value in column 126 for the “Parent Style Name” attribute of column 124. A menu 140 of predefined text styles appears as shown in FIG. 5. The user then uses the GUI to select the name of the predefined text style to be used as the parent text style. Once a parent text style is selected, the attributes for the new text style are set to correspond to the attributes of the parent text style. This may be done by the system evaluating the style hierarchy from this child style's parent up to the ultimate parent style. This evaluated style is then assigned to the new style. Another way to say this is that when a new style is inserted in the hierarchy, any differences between the new style and its parent style are marked as overrides. The user may then further modify the attributes of the child text style. The user selects the value in column 126 corresponding to the attribute to be changed. When a value is selected, a menu, similar to menu 140, that contains the possible values for the attribute opens. The user selects the new value and the attributed is changed. Once the user has made the desired changes, they select File >Save from the menu bar 138 and the child text style is saved.

When the child text style is saved, it is associated with its parent text styles. Each style has a unique identifier in the style system and each style is provided with storage space for the unique identifier of a parent style. A style which has no parent has special identifier describing this feature. The entire child style is saved. This provides the advantage that the entire hierarchy does not need be evaluated to calculate the entire child style settings. Furthermore, by storing redundant data, the non-overridden properties of the parent style, on the child style, the child style is capable of standing alone, so the parent style does not need to be directly accessible in order to make use of the child style. The system creates a text style hierarchy based on the association.

Arranging styles in a hiearchy and associating the parent and child styles with one another allows changes made to the style to be easily propagate to elements in a design file the utilize the changed style. When a change is made to an attribute of a style, essentially, all of the design files that utilize this style are affected globally. The change is automatically propagated to all elements that refer to the changed style. Moreover the change is propagated to all child styles of the changed style and to all elements that refer to the changed styles child styles. For example, when a change is made to a parent style, each style that has the parent style's unique identifier stored therein is also changed. The change can be transmitted throughout the hierarchy by then identify styles that store the unique identifier of the changed child styles, and so on.

An exception to the propagation of changes through the style hierarchy is when an attribute is overridden by a child style. Any attribute that has been overridden and is locally controlled by a child style is not effected if the overridden attribute is changed in one of the child style's parent styles. The override indicator is noted for that attribute and the system does not effect a change for that attribute.

Thus, any change or modification to a style can be made very easily and quickly, affecting a few files to hundreds of files. Modifying design files and elements through a styles is a very powerful administrative tool and can be used to apply design standards across a project.

Accordingly, a system and method providing an optimal way to create, manage and use styles is provided. An user can be provided with a consistent powerful tool to create and manage styles. The styles can be utilized by users to implement standards and make changes to many design files in a simple manner.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described. For example, the sequence of performing the steps of the methods described above may be varied as long as the above-described dependencies are maintained.

What is claimed is:

1. A method for constructing styles, comprising:
accessing a database storing predefined styles;
receiving user input selecting one of the predefined styles;
displaying attributes of the selected predefined style to the user; receiving input from the user modifying attributes of the predefined style; and
storing the modified attributes as a new style.

2. The method of claim 1, further comprising, associating the new style with the selected predefined style.

3. The method of claim 1, further comprising, obtaining the modified attributes from the new style when applying the new style;
obtaining the remaining attributes from the predefined style based on the association; and
storing the attributes in the design file.

4. The method of claim 1, wherein the attributes include at least one of as font type, width, height, slant, super script, subscript and color.

5. The method of claim 1, further comprising creating a hierarchy of styles based on inherited attributes of a style.

6. The method of claim 5, wherein the creating step comprises:
providing each style with a unique identifier; and
storing the unique identifier for an associated parent style in the child style.

7. The method of claim 6, further comprising propagating changes made to an attribute of a parent style to its associated child styles.

8. The method of claim 5, further comprising propagating a change made to a style to all elements and child styles associated with that parent file.

9. The method of claim 1, wherein the hierarchy includes at least one parent level and at least child level below the parent level, the child level inheriting attributes from the parent level.

10. A computer useable information storage medium storing computer readable program code for causing a computer to perform the steps of:
providing a graphical user interface (GUI) for constructing styles;
obtaining predefined styles including predefined attributes from a database;
displaying the predefined styles via the GUI;
receiving input from the GUI to create a new style;
receiving input via the GUI selecting a parent style from the predefined styles;
displaying the predefined attributes of the parent style via the GUI;
receiving input via the GUI modifying the attributes; and
storing the new style including the modified attributes.

11. A computer useable information storage medium of claim 10 further comprising computer readable program code for causing a computer to perform the step of creating an association between the new style and the parent style.

12. A computer useable information storage medium of claim 11 further comprising computer readable program code for causing a computer to perform the step of creating a hierarchy of styles based on the association.

13. A computer useable information storage medium of claim 11 further comprising computer readable program code for causing a computer to perform the step of retrieving attributes of styles based on the hierarchy.

14. A computer useable information storage medium of claim 11 further comprising computer readable program code for causing a computer to perform the step of storing a unique identifier in the child style for its respective parent style.

15. A computer useable information storage medium of claim 14 further comprising computer readable program code for causing a computer to perform the steps of:
identifying child styles storing the unique identifier of parent styles that have at least one of its attributes modified; and
making the same modification made to the parent style to the attributes of the identified child styles.

16. A computer useable information storage medium of claim 14 further comprising computer readable program code for causing a computer to perform the steps of:
identifying elements using a style, which style has had at least one of its attributes modified; and
propagating the modified attributes to the identified elements.
